(19) United States
(12) Patent Application Publication
(10) Pub. No.: US 2025/0260860 A1
(43) Pub. Date: Aug. 14, 2025

(54) DISPLAY APPARATUS AND CONTROL METHOD THEREOF

(71) Applicant: Samsung Electronics Co., Ltd., Suwon-si (KR)

(72) Inventors: Hyejin LEE, Suwon-si (KR); Jongho KIM, Suwon-si (KR); Jiyoon MIN, Suwon-si (KR); Seolhye WON, Suwon-si (KR)

(21) Appl. No.: 19/194,671

(22) Filed: Apr. 30, 2025

Related U.S. Application Data
(63) Continuation of application No. PCT/KR2023/018166, filed on Nov. 13, 2023.

(30) Foreign Application Priority Data
Dec. 30, 2022 (KR) 10-2022-0190638

(51) Int. Cl. H04N 21/431; H04N 21/45; H04N 21/475

(52) U.S. Cl. CPC H04N 21/4312; H04N 21/4532; H04N 21/475

(57) ABSTRACT

A display apparatus is provided. The display apparatus includes communication circuitry configured to communicate with an external device, a display configured to display at least one application, an input portion configured to receive an execution command for the at least one application from a user, memory, including one or more storage media, storing instructions, and a processor communicatively coupled to the communication circuitry, the display, the input portion, and the memory, wherein the instructions, when executed by the processor, cause the display apparatus to control the display to display a plurality of user accounts that were previously logged in in response to receiving the execution command, and control the display to display at least one of the plurality of user accounts differently from remaining user accounts based on communication information with the external device.

### CROSS-REFERENCE TO RELATED APPLICATION(S)

This application is a continuation application, claiming priority under 35 U.S.C. § 365 (c), of an International application No. PCT/KR2023/018166, filed on Nov. 13, 2023, which is based on and claims the benefit of a Korean patent application number 10-2022-0190638, filed on Dec. 30, 2022, in the Korean Intellectual Property Office, the disclosure of which is incorporated by reference herein in its entirety.

### BACKGROUND

### 1. Field

The disclosure relates to a display apparatus and a method for controlling the same. More particularly, the disclosure relates to a display apparatus that logs in to an application and a method for controlling the same.

### 2. Description of Related Art

In general, a display apparatus is an output apparatus for visually displaying image information received from the outside or stored therein for a user. The display apparatus is widely used in various fields, such as home or places of business.

Examples of display apparatuses are a monitor connected with a personal computer (PC), a server computer, or the like, a portable computer, a navigation terminal, a television, an Internet protocol television (IPTV), a portable terminal (for example, a smartphone, a tablet PC, personal digital assistant (PDA), or a cellular phone), various kinds of displays used to reproduce images of advertisements or movies in industrial fields, and various kinds of audio/video systems.

When trying to execute personalized content, such as an application, on a shared device, such as a TV that may run an application that supports login for a plurality of accounts, a user must always log in directly with a user account that the user desires to log in to.

In addition, even on a shared device used by a family, in a case where a family member desires to log in for content, each member must log in separately.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a display apparatus that, when logged in to an application that supports login for a plurality of accounts, determines the most likely user account to log in and perform the login, and a method for controlling the same.

Another aspect of the disclosure is to provide a display apparatus that, in a case where a person's account is registered with the accounts of others, such as family members, registers the accounts of others (family members) in a login history by the login of one family member, and a method for controlling the same.

Additional aspects will be set forth in part in the description which follows and, in part, will be apparent from the description, or may be learned by practice of the presented embodiments.

In accordance with an aspect of the disclosure, a display apparatus is provided. The display apparatus includes communication circuitry configured to communicate with an external device, a display configured to display at least one application, an input portion configured to receive an execution command for the at least one application from a user, memory, including one or more storage media, storing instructions, and a processor communicatively coupled to the communication circuitry, the display, the input portion, and the memory, wherein the instructions, when executed by the processor, cause the display apparatus to control the display to display a plurality of user accounts that were previously logged in in response to receiving the execution command, and control the display to display at least one of the plurality of user accounts differently from remaining user accounts based on communication information with the external device.

The instructions, when executed by the processor, further cause the display apparatus to control the display to display at least one user account differently from the remaining user accounts, the at least one user account being registered on at least one external device that performs short-range communication with the communication circuitry.

The instructions, when executed by the processor, further cause the display apparatus to control the display to display at least one user account differently from the remaining user accounts, the at least one user account being registered on at least one external device connected to the same network as the communication circuitry.

Based on the plurality of user accounts being horizontally arranged and displayed, the instructions, when executed by the processor, further cause the display apparatus to control the display to allow at least one of the plurality of user accounts to be positioned to a left or right side of the remaining user accounts.

Based on the plurality of user accounts being vertically arranged and displayed, the instructions, when executed by the processor further cause the display apparatus to control the display to allow at least one of the plurality of user accounts to be positioned above the remaining user accounts.

The instructions, when executed by the processor, further cause the display apparatus to control the display to display at least one of the plurality of user accounts in a highlighted or selectable state relative to the remaining user accounts.

Based on a plurality of external devices performing short-range communication with the communication circuitry, the instructions, when executed by the processor, further cause the display apparatus to control the display to display a plurality of user accounts registered on the external devices differently from the remaining user accounts, based on at least one of a strength of a signal received from each of the plurality of external devices through the communication circuitry, a number of logins of user accounts registered on the plurality of external devices, or a login order of the user accounts registered on the plurality of external devices.

Based on a single external device performing short-range communication with the communication circuitry, the instructions, when executed by the processor, further cause the display apparatus to perform a login with the user account registered on the external device.

The instructions, when executed by the processor, further cause the display apparatus to receive information of a plurality of external devices, in which the plurality of user accounts that were previously logged in are registered, from a server through long-range communication of the communication circuitry, and control the display to display at least one user account differently from the remaining user accounts, the at least one user account being registered on at least one external device that performs short-range communication with the communication circuitry from among the plurality of external devices in which the plurality of user accounts that were previously logged in are registered.

The instructions, when executed by the processor, further cause the display apparatus to register information about a newly logged-in user account in a login history, based on absence of a previously logged-in user account.

Based on another user's preset account being registered together with the newly logged-in user account, the instructions, when executed by the processor, further cause the display apparatus to register information about the other user's account in the login history.

The instructions, when executed by the processor, further cause the display apparatus to transmit a signal about whether to allow login to the external device, based on receiving a user input for selecting the differently displayed user account, and perform a login to the selected user account, based on receiving a signal that allows login from the external device.

Based on the newly logged-in user account being an account of a child, the instructions, when executed by the processor, further cause the display apparatus to perform a login to the child account in response to a determination that the login is attempted by an external device to which an account of a guardian of the child is registered.

Based on a preset setting value being included in the child's account, the instructions, when executed by the processor, further cause the display apparatus to control the preset setting value to be applied to the logged-in display apparatus.

In accordance with another aspect of the disclosure, a method for controlling a display apparatus is provided. The method includes receiving an execution command for at least one application from a user, displaying a plurality of user accounts that were previously logged in in response to receiving the execution command, and controlling at least one of the plurality of user accounts to be displayed differently from remaining user accounts based on communication information with an external device.

The controlling of the at least one of the plurality of user accounts to be displayed differently include controlling at least one user account, registered on at least one external device that performs short-range communication with communication circuitry configured to communicate with an external device, to be displayed differently from the remaining user accounts.

The controlling of the at least one of the plurality of user accounts to be displayed differently include controlling at least one user account, registered on at least one external device connected to the same network as the communication circuitry configured to communicate with the external device, to be displayed differently from the remaining user accounts.

The controlling of the at least one of the plurality of user accounts to be displayed differently include controlling at least one of the plurality of user accounts to be positioned to a left or right side of the remaining user accounts, based on the plurality of user accounts being horizontally arranged and displayed.

The controlling of the at least one of the plurality of user accounts to be displayed differently include controlling at least one of the plurality of user accounts to be positioned above the remaining user accounts, based on the plurality of user accounts being vertically arranged and displayed.

The controlling of the at least one of the plurality of user accounts to be displayed differently include controlling at least one of the plurality of user accounts to be displayed in a highlighted or selectable state relative to the remaining user accounts.

The controlling of the at least one of the plurality of user accounts to be displayed differently include, in response to a plurality of external devices performing short-range communication with the communication circuitry, controlling a plurality of user accounts registered on the external devices to be displayed differently from the remaining user accounts, based on at least one of a strength of a signal received from each of the plurality of external devices through the communication circuitry, a number of logins of user accounts registered on the plurality of external devices, or a login order of the user accounts registered on the plurality of external devices.

The method further includes performing a login with the user account registered on the external device, based on a single external device performing short-range communication with the communication circuitry.

The controlling of the at least one of the plurality of user accounts to be displayed differently include receiving information of a plurality of external devices, in which the plurality of user accounts that were previously logged in are registered, from a server through long-range communication of the communication circuitry, and controlling at least one user account to be displayed differently from the remaining user accounts, the at least one user account being registered on at least one external device that performs short-range communication with the communication circuitry from among the plurality of external devices in which the plurality of user accounts that were previously logged in are registered.

The method further includes registering information about a newly logged-in user account in a login history, based on absence of a previously logged-in user account.

The method further includes registering information about another user's preset account in the login history, based on the other user's account being registered together with the newly logged-in user account.

The method further includes, based on receiving a user input for selecting the differently displayed user account, transmitting a signal about whether to allow login to the external device, and based on receiving a signal that allows login from the external device, performing a login to the selected user account.

The method further includes, based on the newly logged-in user account being an account of a child, performing a login to the child account in response to a determination that the login is attempted by an external device to which an account of a guardian of the child is registered.

The method further includes, based on a preset setting value being included in the child's account, controlling the preset setting value to be applied to the logged-in display apparatus.

According to an aspect of the disclosure, when logged in to an application that supports login for a plurality of accounts, the most likely user account to log in is determined to perform the login, thereby enabling easy login to a shared device and enhancing a personalized application experience on the shared device.

In addition, in a case where a person's account is registered with the accounts of others, such as family members, the accounts of others (family members) is registered in a login history by the login of one family member, thereby enabling easy login for the others (family members).

In accordance with another aspect of the disclosure, one or more non-transitory computer-readable storage media storing one or more computer programs including computer-executable instructions that, when executed by one or more processors of a display apparatus, individually or collectively, cause the display apparatus to perform operations are provided. The operations include receiving an execution command for at least one application from a user, displaying a plurality of user accounts that were previously logged in in response to receiving the execution command, and controlling at least one of the plurality of user accounts to be displayed differently from remaining user accounts based on communication information with an external device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a control block diagram of a display apparatus according to an embodiment of the disclosure;

FIG. 2 is a diagram illustrating executable applications displayed on a display apparatus according to an embodiment of the disclosure;

FIG. 3 is a diagram illustrating executable applications displayed on a display apparatus according to an embodiment of the disclosure;

FIG. 4 is a diagram illustrating a login screen displayed on a display apparatus according to an embodiment of the disclosure;

FIG. 5 is a flowchart illustrating operations for displaying a user account differently from other accounts according to an embodiment of the disclosure;

FIG. 6 is a diagram illustrating an external device performing short-range communication with a display apparatus according to an embodiment of the disclosure;

FIG. 7 is a diagram illustrating a router, a display apparatus, and an external device each communicating with each other according to an embodiment of the disclosure;

FIGS. 8A, 8B, 8C, 8D, 8E, and 8F are diagrams illustrating various examples of user accounts displayed on a display apparatus according to an embodiment of the disclosure;

FIG. 9 illustrates displaying a user account according to an external device performing short-range communication with communication circuitry according to an embodiment of the disclosure;

FIG. 10 is a diagram illustrating a plurality of external devices performing short-range communication with a display apparatus according to an embodiment of the disclosure;

FIG. 11 is a flowchart illustrating an operation performed in a case where a single external device performs short-range communication with communication circuitry according to an embodiment of the disclosure;

FIG. 12 is a control block diagram of a display apparatus according to an embodiment of the disclosure;

FIG. 13 is a flowchart illustrating a method for controlling a display apparatus in a case where no login history exists according to an embodiment of the disclosure;

FIG. 14 is a diagram illustrating that other person's user accounts are registered together with one user account according to an embodiment of the disclosure;

FIG. 15 is a flowchart illustrating a process for performing a login based on a selection of a displayed user account according to an embodiment of the disclosure;

FIG. 16 is a flowchart illustrating operations performed when logging in with a child account according to an embodiment of the disclosure; and

FIG. 17 is a flowchart illustrating operations performed when logging in with a child account according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

In addition, it is to be understood that when a certain component is referred to as being “connected to,” or “coupled with,” another component, it means that the component may be connected to or coupled with the other component directly or indirectly via a third component.

In addition, although the terms “first”, “second”, or the like, may be used to describe various components, the terms do not limit the corresponding components, but are used only for the purpose of distinguishing one component from another. For example, without departing from the technical spirit or essential features of the disclosure, a first element may be referred to as a second element, and a second element may be referred to as a first element. As used herein, the term “and/or” includes any and all combinations of one or more of the associated listed items.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Hereinafter, an operating principle and embodiments of the disclosure will now be described with reference to accompanying drawings.

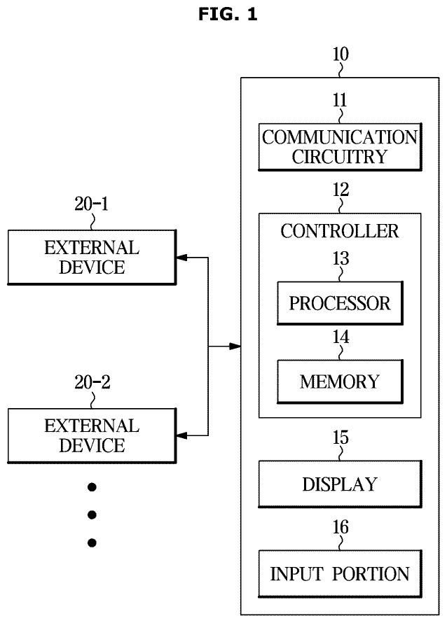

FIG. 1 is a control block diagram of a display apparatus according to an embodiment of the disclosure.

Referring to FIG. 1, a display apparatus 10 may include communication circuitry 11, a display 15, an input portion 16, and a controller 12. The controller 12 may include at least one processor 13 and memory 14.

The display apparatus 10 refers to a device that may display, and examples thereof include a television, and various home appliances and devices equipped with the display 15.

The communication circuitry 11 may perform communication with an external device 20.

Here, the external device 20 may include all kinds of handheld-based wireless communication devices, such as personal communication system (PCS), global system for mobile communications (GSM), personal digital cellular (PDC), personal handyphone system (PHS), personal digital assistant (PDA), international mobile telecommunication (IMT)-2000, code division multiple access (CDMA)-2000, W-code division multiple access (W-CDMA), wireless broadband internet (WiBro) terminals, smartphones, or the like, and wearable devices, such as watches, rings, bracelets, anklets, necklaces, glasses, contact lenses, or head-mounted devices (HMDs).

In the disclosure, for convenience of description, the case where the external device 20 is a smartphone is described as an example.

The communication circuitry 11 may perform communication not only with the external device 20 but also with a server 30.

To this end, the communication circuitry 11 may further include a short-range communication module (not shown) that communicates with the external device 20 and a long-range communication module (not shown) that communicates with the server 30.

The display 15 may display at least one application.

The display 15 may be implemented as any device for displaying to a user, and may be used to display all functions of the display apparatus 10 described below.

The input portion 16 may receive an execution command for at least one application from a user.

The input portion 16 may be provided in the display apparatus 10 to allow the user to directly input to the display apparatus 10, or may receive a user input from an external device, such as a remote control. However, the above-described input portion 16 is only an example, and may be provided in various forms for receiving a user input.

The controller 12 may include the memory 14 that stores a control program and control data for controlling the communication circuitry 11, the input portion 16, and the display 15, and at least one processor 13 that generates a control signal according to the control program and control data stored in the memory 14. The memory 14 and the processor 13 may be provided integrally or separately.

The memory 14 may store account information of a logged-in user, and may store a program and data for controlling the communication circuitry 11, the input portion 16, and the display 15.

The memory 14 may include volatile memory, such as static random access memory (S-RAM) and dynamic random access memory (DRAM) for temporarily storing data. In addition, the memory 14 may include non-volatile memory, such as read only memory (ROM), erasable programmable read only memory (EPROM), and electrically erasable programmable read only memory (EEPROM) for long-term data storage.

The processor 13 may include various logic circuits and operation circuits, and may process data according to a program provided from the memory 14 and generate a control signal according to the processing result.

The controller 12 may control the display 15 to display a plurality of logged-in user accounts in response to receiving an execution command. In addition, the controller 12 may control the display 15 to display at least one of the plurality of user accounts differently from the remaining user accounts based on communication information with the external device 20.

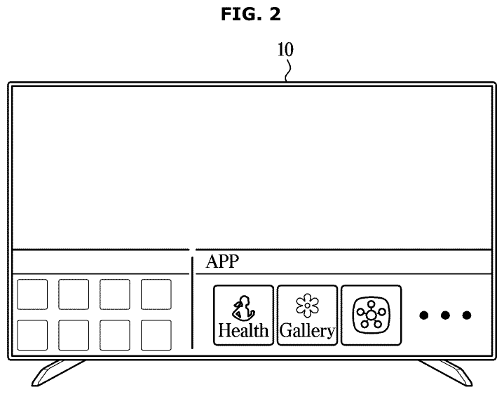

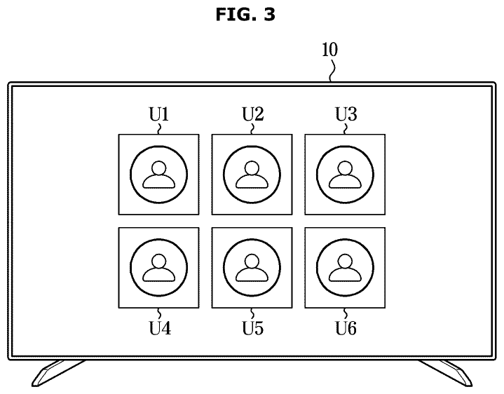

FIG. 2 is a diagram illustrating executable applications displayed on a display apparatus according to an embodiment of the disclosure. FIG. 3 is a diagram illustrating a login screen displayed on a display apparatus according to an embodiment of the disclosure.

The display apparatus 10 may display at least one application, i.e., the display apparatus 10 may display an executed application itself, as well as display an icon of an application for executing the application, or the like.

Referring to FIG. 2, it may be seen that an icon of at least one executable application is displayed on the display apparatus 10.

Various applications may be executed through the display apparatus 10, such as a health application related to the user's health, a gallery application for viewing saved photos, and an application for connecting with other devices to perform various controls.

Because such applications often display different information for each user, a separate login is required for each user.

Accordingly, upon execution of the application, a separate screen for login with a user account may be displayed.

Referring to FIG. 3, a screen where a plurality of user accounts U1, U2, U3, U4, U5, and U6 for login to an application displayed on the display apparatus 10 is shown. The user accounts may be displayed in the form of icons.

The user accounts displayed upon execution of the application may be a user account that already has a login history to the application.

The user may log in to the user account by selecting one of the displayed user accounts.

In a case where the process of finding and selecting a user account for login is repeated each time the application is executed, it may be cumbersome and reduce user convenience in using the application.

Accordingly, a method for selecting a likely account to log in to the application and facilitating the login is described below.

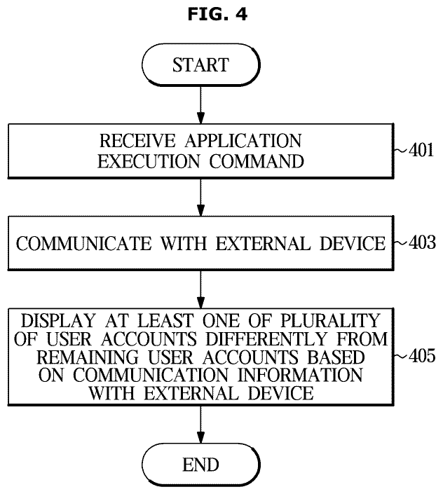

FIG. 4 is a flowchart illustrating a method for controlling a display apparatus according to an embodiment of the disclosure.

Referring to FIG. 4, based on receiving an execution command for at least one application from a user in operation 401, the communication circuitry 11 may perform communication with the external device 20 in operation 403.

The communication between the communication circuitry 11 and the external device 20 may already be performed even before a user executes an application.

The controller 12 may control to allow a plurality of user accounts that were previously logged in to be displayed in response to receiving the execution command.

The controller 12 may control to allow at least one of the plurality of user accounts to be displayed differently from the remaining user accounts based on the communication information with the external device 20 in operation 405.

Hereinafter, displaying at least one of the plurality of user accounts differently from the remaining user accounts is described below.

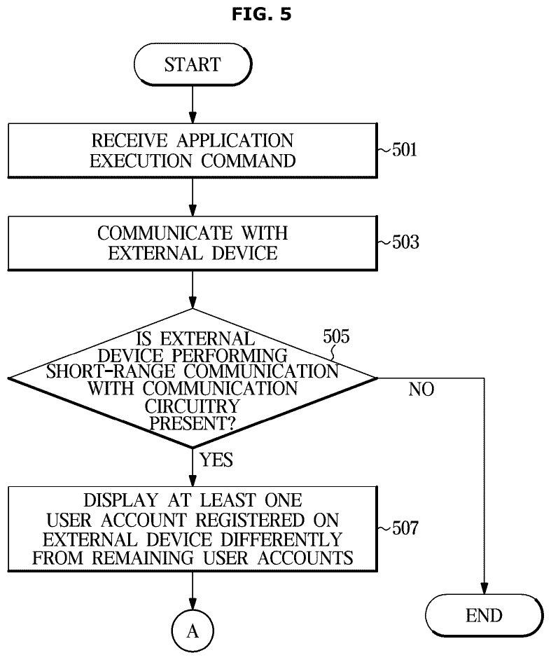

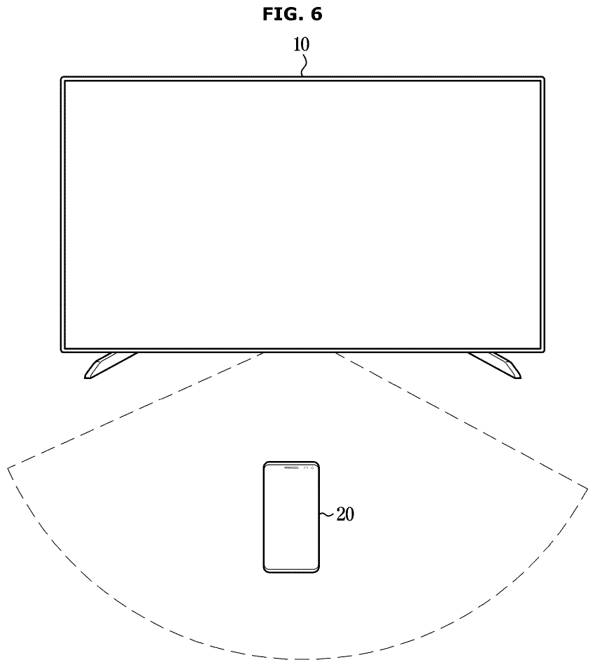

FIG. 5 is a flowchart illustrating operations for displaying a user account differently from other accounts according to an embodiment of the disclosure. FIG. 6 is a diagram illustrating the external device 20 performing short-range communication with a display apparatus according to an embodiment of the disclosure.

Referring to FIG. 5, based on receiving an execution command for at least one application from a user in operation 501, the communication circuitry 11 may perform communication with the external device 20 in operation 503.

The communication between the communication circuitry 11 and the external device 20 may already be performed even before a user executes the application.

The controller 12 may determine whether at least one external device 20 performing short-range communication with the communication circuitry 11 is present.

Here, the short-range communication method may be one of Bluetooth, Bluetooth low energy, infrared data association (IrDA), Zigbee, Wi-Fi, Wi-Fi direct, ultra wideband (UWB), or near field communication (NFC).

For example, referring to FIG. 6, in a case where the external device 20 exists around the display apparatus 10, short-range communication may be performed between the display apparatus 10 and the external device 20 through a short-range communication module (not shown) of the communication circuitry 11 of the display apparatus 10.

Although a case where a single external device 20 exists around the display apparatus 10 and performs short-range communication is illustrated in FIG. 6, the number of external devices 20 that may perform short-range communication with the display apparatus 10 is not limited.

In a case where at least one external device 20 performing short-range communication with the communication circuitry 11 is present (Yes in operation 505), the controller 12 may control the display 15 to display at least one user account, registered on the at least one external device 20 performing short-range communication with the communication circuitry 11, differently from the remaining user accounts in operation 507.

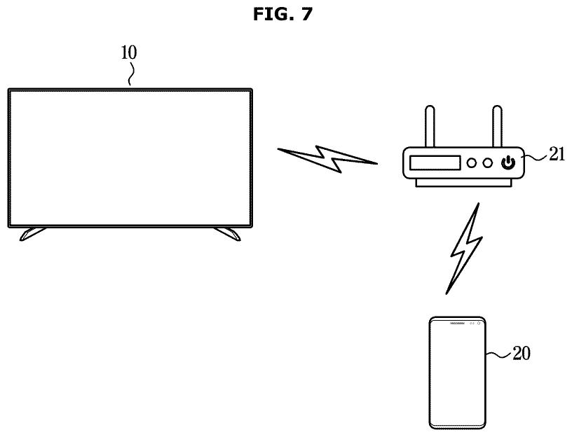

FIG. 7 is a diagram illustrating a router, a display apparatus, and an external device each communicating with each other according to an embodiment of the disclosure.

In FIG. 6, the external device 20 that performs direct short-range communication with the display apparatus 10 was described.

Differently from the above, referring to FIG. 7, the external device 20 connected to the same network as the display apparatus 10 may be recognized.

The controller 12 may control the display 15 to display at least one user account, registered on at least one external device 20 connected to the same network as the communication circuitry 11, differently from the remaining user accounts.

For example, in a case where the communication circuitry 11 of the display apparatus 10 communicates with the router 21 and is connected to a network, such as Wi-Fi, and the external device 20 also communicates with the same router 21 and is connected to the same network, such as Wi-Fi as the display apparatus 10, the controller 12 may control the display 15 to display at least one user account, registered on at least one external device 20 connected to the same network as the communication circuitry 11, differently from the remaining user accounts.

The communication circuitry 11 may receive information about the external device 20 connected to the same network from the router 21, and thus may identify the at least one external device 20 connected to the same network as the communication circuitry 11.

In this instance, the router 21 may be included in the external device 20 described above. For example, display of a user account may be controlled based on communication information between the display apparatus 10 and the router 21 which is the external device 20.

Hereinafter, described is a method for displaying at least one user account, registered on at least one external device 20 that performs short-range communication with the communication circuitry 11 or is connected to the same network as the communication circuitry 11, differently from the remaining user accounts.

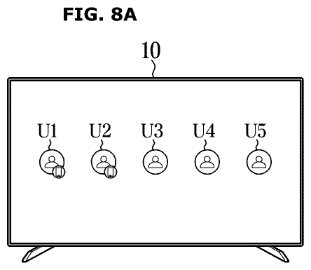

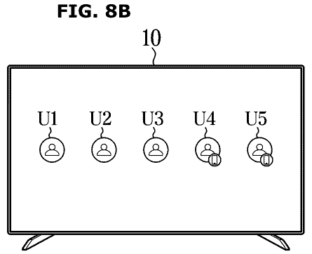

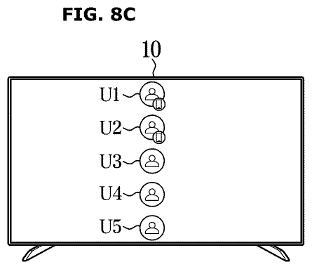

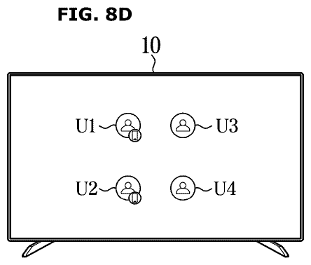

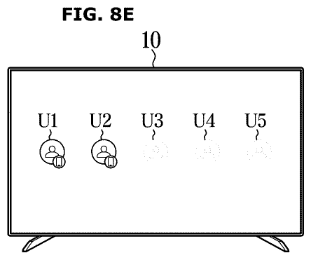

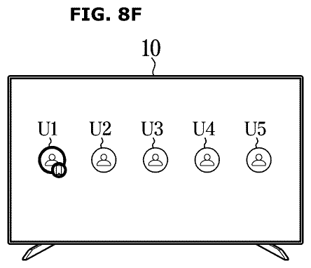

FIGS. 8A, 8B, 8C, 8D, 8E, and 8F are diagrams illustrating various examples of user accounts displayed on a display apparatus according to an embodiment of the disclosure.

As described above, the controller 12 may control the display 15 to display a plurality of user accounts U1, U2, U3, U4, and U5 that were previously logged in.

Referring to FIGS. 8A, 8B, 8C, 8D, 8E, and 8F, at least one user account registered on at least one external device 20 that performs short-range communication with the communication circuitry 11 or is connected to the same network as the communication circuitry 11 may be displayed by including a separate smartphone-shaped icon, allowing a user to easily identify the user account. However, the smartphone-shaped icon is only an example and may be expressed in various forms.

In a case where a plurality of user accounts are horizontally arranged and displayed, the controller 12 may control the display 15 to allow at least one of the plurality of user accounts to be positioned to the left or right of the remaining user accounts.

In addition, in a case where a plurality of user accounts are vertically arranged and displayed, the controller 12 may control the display 15 to allow at least one of the plurality of user accounts to be positioned above the remaining user accounts.

In addition, the controller 12 may control the display 15 to display at least one of the plurality of user accounts in a highlighted or selectable state relative to the remaining user accounts.

The above-described embodiment is described below with reference to FIGS. 8A, 8B, 8C, 8D, 8E, and 8F.

FIGS. 8A and 8B are drawings illustrating that a plurality of user accounts U1, U2, U3, U4, and U5, that were previously logged in, are horizontally arranged and displayed.

Referring to FIG. 8A, the controller 12 may control the display 15 to allow at least one user account U1 and U2, registered on at least one external device 20 that performs short-range communication with the communication circuitry 11 or is connected to the same network as the communication circuitry 11, to be positioned to the left of the remaining user accounts U3, U4, and U5.

Referring to FIG. 8B, the controller 12 may control the display 15 to allow at least one user account U4 and U5, registered on at least one external device 20 that performs short-range communication with the communication circuitry 11 or is connected to the same network as the communication circuitry 11, to be positioned to the right of the remaining user accounts U1, U2, and U3.

By positioning a user account that is likely to log in to the left or right of the remaining accounts and displaying the user account differently as described above, the user may easily identify the account to log in to.

Referring to FIG. 8C, it illustrates that a plurality of user accounts U1, U2, U3, U4, and U5 that were previously logged in are vertically arranged and displayed.

The controller 12 may control the display 15 to allow at least one user account U1 and U2, registered on at least one external device 20 that performs short-range communication with the communication circuitry 11 or is connected to the same network as the communication circuitry 11, to be positioned above the remaining user accounts U3, U4, and U5.

By positioning a user account that is likely to log in above the remaining accounts and displaying the user account differently, the user may easily identify the account to log in to.

In addition, depending on circumstances, the controller 12 may control the display 15 to allow at least one user account U1 and U2, registered on at least one external device 20 that performs short-range communication with the communication circuitry 11 or is connected to the same network as the communication circuitry 11, to be positioned below the remaining user accounts U3, U4, and U5.

Referring to FIG. 8D, it illustrates that a plurality of user accounts U1, U2, U3, U4, and U5 that were previously logged in are arranged and displayed in a matrix form of two rows and two columns.

In this instance, the controller 12 may control the display 15 to allow at least one user account U1 and U2, registered on at least one external device 20 that performs short-range communication with the communication circuitry 11 or is connected to the same network as the communication circuitry 11, to be arranged in the first column.

In addition, the controller 12 may control the display 15 to allow at least one user account U1 and U2, registered on at least one external device 20 that performs short-range communication with the communication circuitry 11 or is connected to the same network as the communication circuitry 11, to be arranged in the first row.

Referring to FIG. 8E, it illustrates that at least one user account U1 and U2, registered on at least one external device 20 that performs short-range communication with the communication circuitry 11 or is connected to the same network as the communication circuitry 11, is highlighted.

For example, by blurring the remaining user accounts U3, U4, and U5 except for at least one user account U1 and U2 registered on at least one external device 20 that performs short-range communication with the communication circuitry 11 or is connected to the same network as the communication circuitry 11, the at least one user account U1 and U2 registered on the at least one external device 20 that performs short-range communication with the communication circuitry 11 or is connected to the same network as the communication circuitry 11 may be highlighted.

The above examples are merely an example of highlighting, and may be implemented in various forms, such as adding a separate mark to highlight the at least one user account U1 and U2 registered on at least one external device 20 that performs short-range communication with the communication circuitry 11 or is connected to the same network as the communication circuitry 11.

Referring to FIG. 8F, it illustrates that at least one user account U1, registered on at least one external device 20 that performs short-range communication with the communication circuitry 11 or is connected to the same network as the communication circuitry 11, is displayed in a selectable state.

For example, when a screen for login is displayed, at least one user account U1, registered on at least one external device 20 that performs short-range communication with the communication circuitry 11 or is connected to the same network as the communication circuitry 11, may be displayed to be selectable immediately.

In this instance, the user may immediately select an account to log in to by simply operating an input button or the like.

As described above, at least one user account registered on at least one external device 20 that performs short-range communication with the communication circuitry 11 or is connected to the same network as the communication circuitry 11 may be displayed in various ways to be different from the remaining user accounts.

The examples shown in FIGS. 8A, 8B, 8C, 8D, 8E, and 8F are merely an example, and various embodiments for different display may be further included.

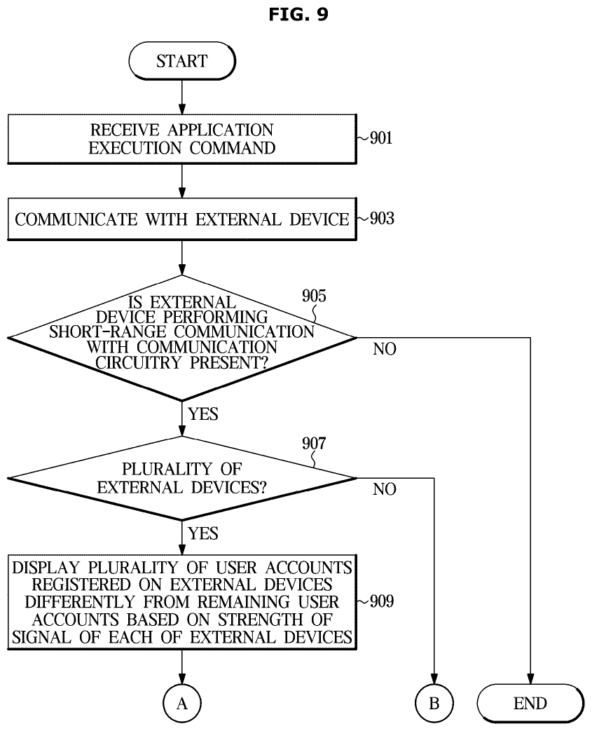

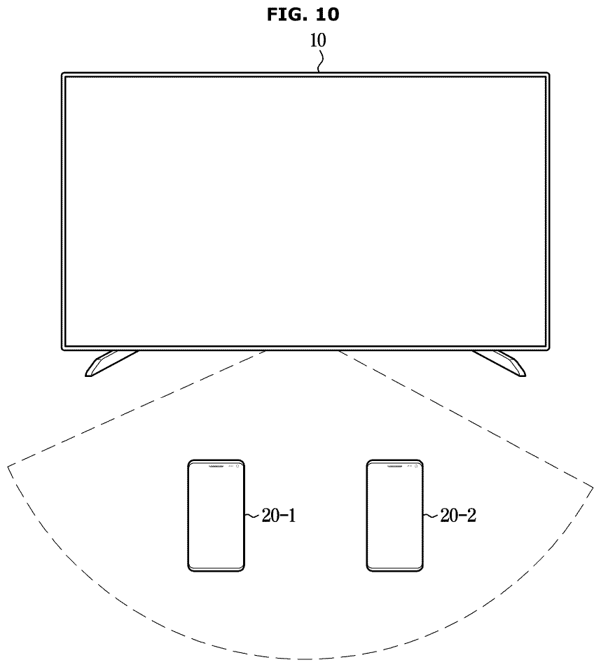

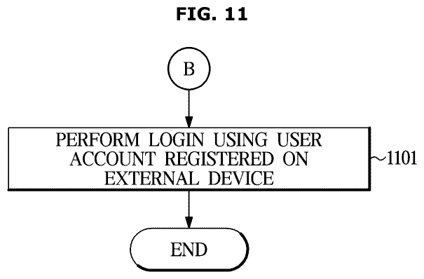

FIG. 9 illustrates displaying a user account according to an external device performing short-range communication with the communication circuitry according to an embodiment of the disclosure. FIG. 10 is a diagram illustrating a plurality of external devices performing short-range communication with a display apparatus according to an embodiment of the disclosure. FIG. 11 is a flowchart illustrating an operation performed in a case where a single external device performs short-range communication with the communication circuitry according to an embodiment of the disclosure.

Referring to FIG. 9, based on receiving an execution command for at least one application from a user in operation 901, the communication circuitry 11 may perform communication with the external device 20 in operation 903.

The communication between the communication circuitry 11 and the external device 20 may already be performed even before the user executes the application.

The controller 12 may determine whether an external device 20 performing short-range communication with the communication circuitry 11 is present.

In a case where the external device 20 performing short-range communication with the communication circuitry 11 is present (Yes in operation 905), it may be determined whether a plurality of external devices 20 are present.

Referring to FIG. 10, in a case where the plurality of external devices 20 performing short-range communication with the communication circuitry 11 are present (Yes in operation 907), the controller 12 may control the display 15 to display a plurality of user accounts registered on the external devices 20 differently from the remaining user accounts based on a strength of a signal received from each of the external devices 20 through the communication circuitry 11 in operation 909.

For example, in FIG. 10, in a case where a signal strength of a specific external device 20 (20-1) received through the communication circuitry 11 is stronger than a signal strength of another external device 20 (20-2), a user account registered on the external device 20 (20-1) may be determined as the most likely account to log in and displayed differently.

Referring to FIGS. 8A, 8B, 8C, 8D, 8E, and 8F, the user account registered on the specific external device 20 (20-1) may be displayed by positioning the user account on the far left, far right, or above, or in a highlighted or selectable state.

The controller 12 may consider other conditions to determine a user account likely to log in, in a case where a plurality of external devices 20 performing short-range communication with the communication circuitry 11 are present.

For example, the number of logins of user accounts registered on each of the plurality of external devices 20 performing short-range communication with the communication circuitry 11 may be considered.

In a case where a particular user account has a large number of logins, the user account is highly likely to be logged in, and thus the most likely user account may be determined by considering the number of logins.

In addition, a login order of user accounts registered on each of the plurality of external devices 20 performing short-range communication with the communication circuitry 11 may be considered.

The user account that has a recent login history is highly likely to be logged in, and thus the most likely user account may be determined by considering the login order.

However, determining the most likely user account based on the above-described signal strength, number of logins, or login order is merely an example, and the most likely user account may be determined by various methods.

Referring to FIG. 6, in a case where a single external device 20 performing short-range communication with the communication circuitry 11 is present, the controller 12 may perform a login using a user account registered on the external device 20 in operation 1101.

For example, in a case where the most likely user account is a single user account, a login to the user account may be performed.

The above description has been made with respect to the external device 20 performing short-range communication with the communication circuitry 11. However, as described above, the same may be applied to the external device 20 connected to the same network as the communication circuitry 11.

For example, the controller 12 may determine whether the external device 20 connected to the same network as the communication circuitry 11 is present, and in a case where the external device 20 connected to the same network as the communication circuitry 11 is present, it may be determined whether a plurality of external devices 20 are present.

In a case where the plurality of external devices 20 connected to the same network as the communication circuitry 11 are present, the controller 12 may control the display 15 to display the plurality of user accounts registered on the external devices 20 differently from the remaining user accounts based on a strength of a signal received from each of the external devices 20 through the communication circuitry 11.

In addition, one of the plurality of external devices 20 may perform short-range communication with the communication circuitry 11, and another of the plurality of external devices 20 may be connected to the same network as the communication circuitry 11.

In this case, at least one user account registered on the external device 20 performing short-range communication with the communication circuitry 11 may be displayed differently from the remaining user accounts.

In addition, depending on the type of short-range communication, at least one user account registered on the external device 20 connected to the same network as the communication circuitry 11 may be displayed differently from the remaining user accounts. Various criteria may be established depending on the degree of likelihood of login.

Hereinafter, a process for linking between a user account and the external device 20 performing short-range communication with the communication circuitry 11 is described.

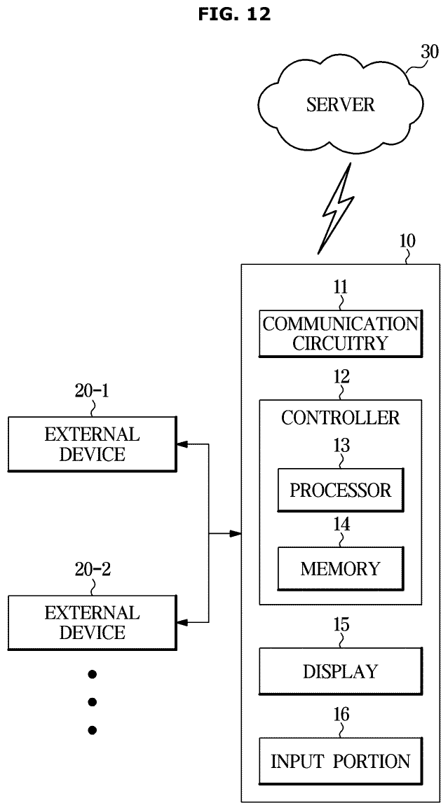

FIG. 12 is a control block diagram of a display apparatus according to an embodiment of the disclosure.

Referring to FIG. 12, the communication circuitry 11 of the display apparatus 10 may perform communication with the server 30.

To this end, the communication circuitry 11 may include a long-range communication module (not shown) for long-range communication.

The communication circuitry 11 may receive information about a plurality of external devices 20, in which a plurality of user accounts that were previously logged in are registered, from the server 30 through long-range communication.

For example, information about the external device 20, such as a smartphone in which a user account having a login history to an application is registered, may be received.

Thereafter, the controller 12 may search for an external device 20 that matches the information about the external device 20 received from the server 30 among the external devices 20 performing short-range communication with the communication circuitry 11 through short-range communication.

In a case where the external device 20 that matches the information about the external device 20 received from the server 30 is present among the external devices 20 performing short-range communication with the communication circuitry 11, the display 15 may be controlled to display the user account registered on the external device 20 differently from the remaining user accounts.

For example, among the plurality of external devices 20 in which a plurality of user accounts that were previously logged in are registered, the display 15 may be controlled to display at least one user account registered on at least one external device 20 performing short-range communication with the communication circuitry 11 differently from the remaining user accounts.

In addition, information about the external device 20 in which a logged-in user account is registered may be stored in the display apparatus 10.

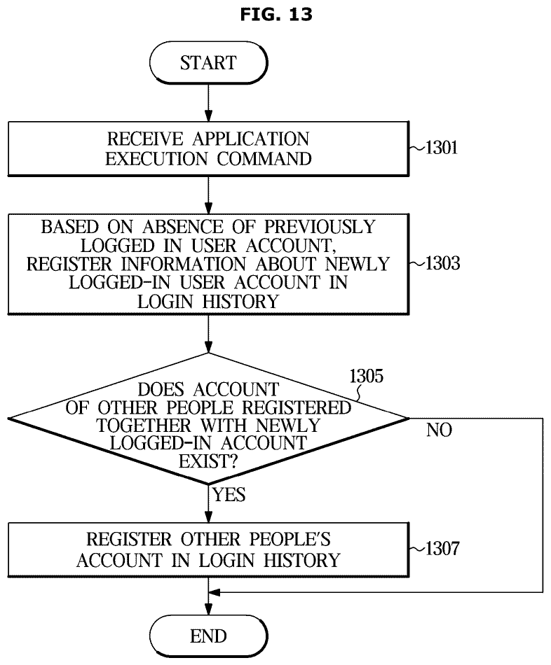

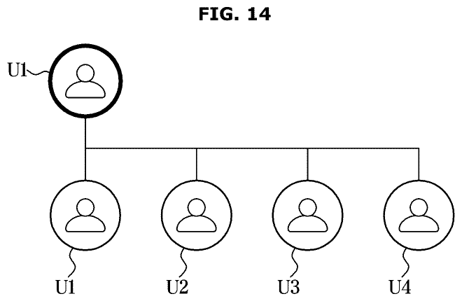

FIG. 13 is a flowchart illustrating a method for controlling a display apparatus in a case where no login history exists according to an embodiment of the disclosure. FIG. 14 is a diagram illustrating that other person's user accounts are registered together with one user account according to an embodiment of the disclosure.

Referring to FIGS. 13 and 14, based on receiving an application execution command from a user in operation 1301, the above-described login process may be performed.

However, there may be cases where there is no user account that has been previously logged in to the application.

In this case, a new login may be performed by directly entering a user ID and password, and in this instance, the controller 12 may register information about the newly logged-in user account in a login history in operation 1303.

For example, when the application is executed again later, the newly logged-in user account may be added to the plurality of user accounts that were previously logged in.

Recently, there are cases where a specific user account is registered together with the user accounts of other people, such as family members.

Through the above, user inconvenience of separately performing various contents, and the like, among family members may be reduced, and the accounts of other family members may be included in the account of a specific user, such as a representative member, so that when the representative member's account performs a specific process, the accounts of the remaining family members may also be affected.

As shown in FIG. 14, it is determined in operation 1305 whether an account U1 of a representative member of family members may be registered together with accounts U2, U3, and U4 of the remaining family members including the representative member.

In this instance, in a case where the representative member's account U1 is newly logged in to an application of the display apparatus 10, when registering information of the logged-in user account in a login history, the account information of the remaining family members registered together may be registered in the login history in operation 1307.

For example, in a case where a preset other person's account is registered together with the newly logged-in user account, the controller 12 may register the account information of the other person registered together in the login history.

Accordingly, the inconvenience of having to log in individually for each family member may be eliminated.

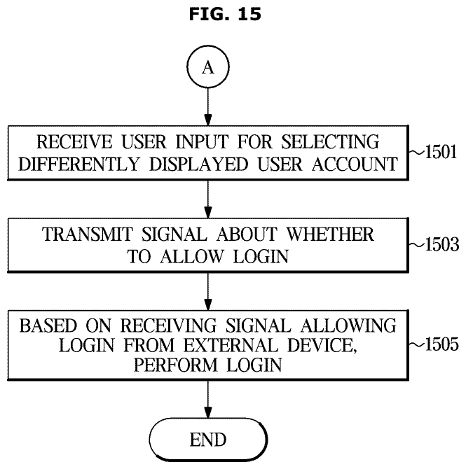

FIG. 15 is a flowchart illustrating a process for performing a login based on a selection of a displayed user account according to an embodiment of the disclosure.

Displaying the most likely user account differently from the remaining user accounts has been described above.

Referring to FIG. 15, in a case where a user selects a user account differently displayed, i.e., when receiving a user input for selecting the differently displayed user account in operation 1501, a signal about whether to allow login may be transmitted to an external device 20 in which the selected user account is registered in operation 1503.

Various forms of signals, such as a text message, push message, or web message, may be implemented and the form of the signal is not limited.

In a case where the user makes an input for login in response to the signal, i.e., when a signal allowing login is received from the external device 20, the controller 12 may perform a login with the selected user account in operation 1505.

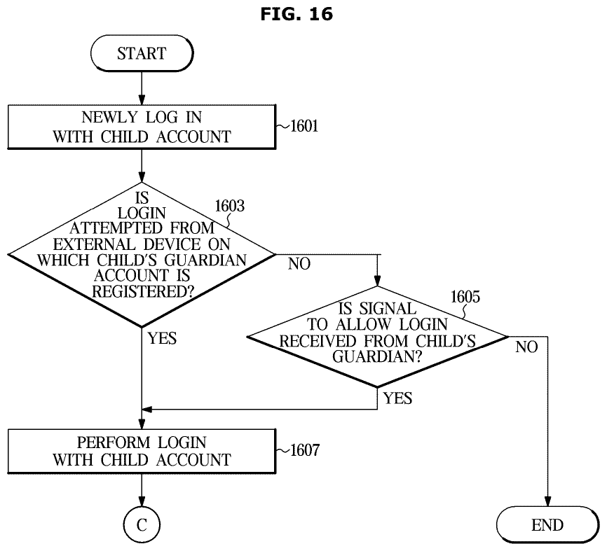

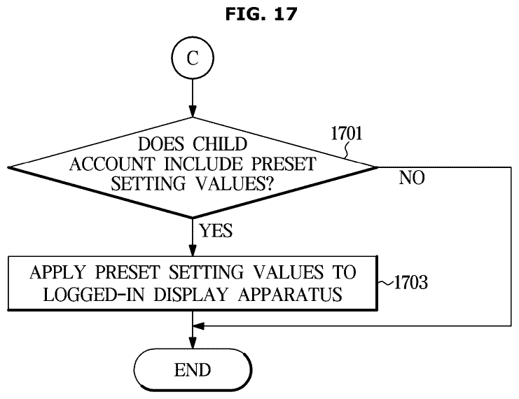

FIGS. 16 and 17 are flowcharts illustrating operations performed when logging in with a child account according to various embodiments of the disclosure.

There may be a case where a user attempts to log in to an application with a child account.

Referring to FIG. 16, in a case where a newly logged-in user account is the child account (in operation 1601), the controller 12 may determine whether the login is attempted from an external device 20 where an account of a guardian of the child is registered. Based on determining that the login is attempted from the external device 20 where the child's guardian account is registered (Yes in operation 1603), the login may be performed with the child account in operation 1607.

Based on determining that the login is not attempted from the external device 20 where the child's guardian account is registered (No in operation 1603), a signal to allow login may be transmitted to the external device 20 where the child's guardian account is registered. Based on receiving the signal to allow login (Yes in operation 1605), the login may be performed with the child account in operation 1607.

As such, in order to protect the child, whether the login is attempted from the guardian's reliable device, and the like, may be determined to perform a login.

Referring to FIG. 17, in addition, in a case where the login was performed with the child account and the child account includes preset setting values (Yes in operation 1701), the preset setting values may be applied to the logged-in display apparatus 10 in operation 1703.

In other words, setting values for content restrictions based on the child's age, or the like, may be stored in the child account in advance by the child's guardian, and the like.

The setting value may further include not only age-based content restrictions, but also preset device usage time or permission to use specific applications for the child account. However, the above examples are merely an example of the setting value, and may further include various settings that may be set with respect to the child account.

In performing a login with the child account, in a case where the child account includes the preset setting values, a signal about whether to maintain the setting values may be transmitted to the external device 20 where the child's guardian account is registered.

In a case where the signal to maintain the setting values is received, the preset setting values may be applied to the logged-in display apparatus 10, and in a case where the signal to maintain the setting values is not received, a default setting value may be applied.

According to an aspect of the disclosure, when logged in to an application that supports login for a plurality of accounts, the most likely user account to log in may be determined to perform the login, thereby enabling easy login to a shared device and enhancing a personalized application experience on the shared device.

In addition, in a case where a person's account is registered with the accounts of others, such as family members, the accounts of others (family members) may be registered in a login history by the login of one family member, thereby enabling easy login for the others (family members).

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be read only memory (ROM), random access memory (RAM), magnetic tape, magnetic disk, flash memory, optical data storage device, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A display apparatus comprising:
communication circuitry configured to communicate with an external device;
a display configured to display at least one application;
an input portion configured to receive an execution command for the at least one application from a user;
memory, comprising one or more storage media, storing instructions; and
a processor communicatively coupled to the communication circuitry, the display, the input portion, and the memory,
wherein the instructions, when executed by the processor, cause the display apparatus to:
control the display to display a plurality of user accounts that were previously logged in in response to receiving the execution command, and
control the display to display at least one of the plurality of user accounts differently from remaining user accounts based on communication information with the external device.

2. The display apparatus of claim 1, wherein the instructions, when executed by the processor, further cause the display apparatus to control the display to display at least one user account differently from the remaining user accounts, the at least one user account being registered on at least one external device that performs short-range communication with the communication circuitry.

3. The display apparatus of claim 1, wherein the instructions, when executed by the processor, further cause the display apparatus to control the display to display at least one user account differently from the remaining user accounts, the at least one user account being registered on at least one external device connected to the same network as the communication circuitry.

4. The display apparatus of claim 1, wherein, based on the plurality of user accounts being horizontally arranged and displayed, the instructions, when executed by the processor, further cause the display apparatus to control the display to allow at least one of the plurality of user accounts to be positioned to a left or right side of the remaining user accounts.

5. The display apparatus of claim 1, wherein, based on the plurality of user accounts being vertically arranged and displayed, the instructions, when executed by the processor, further cause the display apparatus to control the display to allow at least one of the plurality of user accounts to be positioned above the remaining user accounts.

6. The display apparatus of claim 1, wherein the instructions, when executed by the processor, further cause the display apparatus to control the display to display at least one of the plurality of user accounts in a highlighted or selectable state relative to the remaining user accounts.

7. The display apparatus of claim 2, wherein, in response to a plurality of external devices performing short-range communication with the communication circuitry, the instructions, when executed by the processor, further cause the display apparatus to control the display to display a plurality of user accounts registered on the external devices differently from the remaining user accounts, based on at least one of a strength of a signal received from each of the plurality of external devices through the communication circuitry, a number of logins of user accounts registered on the plurality of external devices, or a login order of the user accounts registered on the plurality of external devices.

8. The display apparatus of claim 2, wherein, based on a single external device performing short-range communication with the communication circuitry, the instructions, when executed by the processor, further cause the display apparatus to perform a login with the user account registered on the external device.

9. The display apparatus of claim 2, wherein the instructions, when executed by the processor, further cause the display apparatus to:
receive information of a plurality of external devices, in which the plurality of user accounts that were previously logged in are registered, from a server through long-range communication of the communication circuitry, and
control the display to display at least one user account differently from the remaining user accounts, the at least one user account being registered on at least one external device that performs short-range communication with the communication circuitry from among the plurality of external devices in which the plurality of user accounts that were previously logged in are registered.

10. The display apparatus of claim 1, wherein the instructions, when executed by the processor, further cause the display apparatus to register information about a newly logged-in user account in a login history, based on absence of a previously logged-in user account.

11. The display apparatus of claim 10, wherein, based on another user's preset account being registered together with the newly logged-in user account, the instructions, when executed by the processor, further cause the display apparatus to register information about the other user's account in the login history.

12. The display apparatus of claim 1, wherein the instructions, when executed by the processor, further cause the display apparatus to:
transmit a signal about whether to allow login to the external device, based on receiving a user input for selecting differently displayed user account, and
perform a login to the selected user account, based on receiving a signal that allows login from the external device.

13. The display apparatus of claim 10, wherein, based on the newly logged-in user account being an account of a child, the instructions, when executed by the processor, further cause the display apparatus to perform a login to the child account in response to a determination that the login is attempted by an external device to which an account of a guardian of the child is registered.

14. The display apparatus of claim 13, wherein, based on a preset setting value being included in the child's account, the instructions, when executed by the processor, further cause the display apparatus to control the preset setting value to be applied to logged-in display apparatus.

15. A method for controlling a display apparatus, the method comprising:
receiving an execution command for at least one application from a user;
displaying a plurality of user accounts that were previously logged in in response to receiving the execution command; and
controlling at least one of the plurality of user accounts to be displayed differently from remaining user accounts based on communication information with an external device.

16. The method of claim 15, further comprising:
displaying at least one user account differently from the remaining user accounts, the at least one user account being registered on at least one external device that performs short-range communication with a communication circuitry.

17. The method of claim 15, further comprising:
displaying at least one user account differently from the remaining user accounts, the at least one user account being registered on at least one external device connected to the same network as a communication circuitry.

18. The method of claim 15, further comprising:
based on the plurality of user accounts being horizontally arranged and displayed, allowing at least one of the plurality of user accounts to be positioned to a left or right side of the remaining user accounts.

19. One or more non-transitory computer-readable storage media storing one or more computer programs including computer-executable instructions that, when executed by one or more processors of a display apparatus, individually or collectively, cause the display apparatus to perform operations, the operations comprising:
receiving an execution command for at least one application from a user;
displaying a plurality of user accounts that were previously logged in in response to receiving the execution command; and
controlling at least one of the plurality of user accounts to be displayed differently from remaining user accounts based on communication information with an external device.

20. The one or more non-transitory computer-readable storage media of claim 19, the operations further comprising:
displaying at least one user account differently from the remaining user accounts, the at least one user account being registered on at least one external device that performs short-range communication with a communication circuitry.
